(19) United States
(12) Patent Application Publication
(10) Pub. No.: US 2011/0243675 A1
(43) Pub. Date: Oct. 6, 2011

(54) HOLE SAW

(76) Inventor: Axel Fach, Remscheid (DE)

(21) Appl. No.: 12/737,698

(22) PCT Filed: Jul. 17, 2009
(86) PCT No.: PCT/EP2009/005215

§ 371 Date: Jun. 15, 2011

(30) Foreign Application Priority Data
Aug. 8, 2008 (DE) 10 2008 036 941.1

(51) Int. Cl. B27B 5/12

(52) U.S. Cl. 408/204

(57) ABSTRACT

A hole saw having a cylindrical configuration and having hard particles disposed on both ends thereof, and a clamping surface between the ends for fixing in a drill chuck.

The invention is directed to a hole saw, composed of a base body having a cylindrical contour and of hard particles annularly arranged on the base body endwise thereof.

Such hole saws are used, for example, to drill holes of only a few millimeters in ceramic tiles or the like, so that, for example, a dowel hole can be made in the wall behind them.

For this purpose, the hole saw is provided at one end with a hard-particle coating that is able to cut annularly through hard ceramic material, thereby creating a hole in the tile.

Such hole saws are typically only a few millimeters in diameter.

These hole saws also make it possible, among other things, to prevent a tile that is joined to the wall from cracking under the action of a percussion or hammer drill, for example when a rack or the like is to be mounted in a bathroom.

Such hole saws are actually consumable tools.

The object of the invention is to refine the known hole saws in such a way as to increase their utility value.

The invention achieves this object by means of the features of the main claim.

The advantage arising from the invention is that either the service life of a single tool is doubled in a simple manner, and/or that one and the same tool can be used to produce holes of different diameters.

This advantage is achieved by the fact that both ends of the cylindrical base body are now coated with the inherently known adhesive particles and are therefore available as chip-removing tool ends.

The tool according to the invention can, under these circumstances, have the same diameter at both ends or different diameters at each end.

The cylindrical contour can, for example, have a regular hexagonal cross section, to make it possible to hold the keyhole saw according to the invention nonrotatably in a standard three-jaw chuck.

The hole saw according to the invention can also have an annular cross section, i.e., consist of a pipe section of constant or varying diameter, in which case a clamping surface that mates with a clamping chuck must be provided on the outer circumference at each end.

The pipe cross section is advantageously straight-cylindrical in each case, apart from any necessary region of transition from the smaller to the larger cross section.

The hollow-interior hole saw is therefore able to accommodate the sawed-out piece of ceramic as soon as the hole saw has gone through the tile.

If the hole saw according to the invention is further given a colored coating, for example if it is varnished or powder-coated, its wear status can also easily be perceived at a distance, thus making it possible to take any desired steps to correct the deficit in a timely manner.

The invention will be explained in more detail below on the basis of exemplary embodiments.

In the figures:

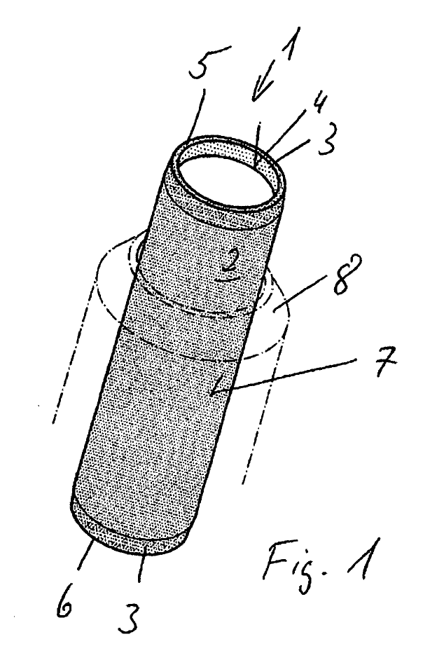

FIG. 1 shows the hole saw according to the invention with a cross section that remains constant over its length;

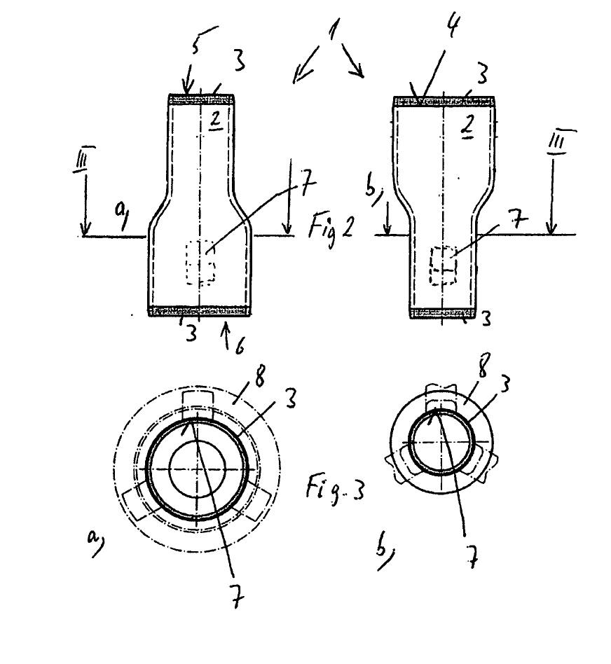

FIGS. 2a-b show the hole saw according to the invention with two different tool diameters in two different clamping situations

FIGS. 3a-b show the clamping situations of FIGS. 2a-b, viewed in direction III-III

Unless otherwise stated below, the following description applies to all the figures alike.

The figures show a hole saw 1.

Such holes saws are composed of a base body 2 having a cylindrical contour.

The base body 2 can be, but is not necessarily, hollow on the inside.

It is also conceivable to hollow out the base body at the ends only and to configure it as a solid body in the middle axial region, for example so that high clamping forces can be applied.

The base body 2 has a coating of hard particles 3 at one end face 4.

These are, for example, synthetic diamond or carbide particles.

Now, it is essential to the invention that the hard particles 3 be applied to both ends 5, 6 of the base body 2.

This results in a tool which in practice has two working ends, which are either identically matching or which differ in their dimensions.

A tool of this kind, in the exemplary embodiment of FIG. 1, can therefore be used to saw twice as many holes as a conventional hole saw of this construction.

A tool according to the exemplary embodiments of FIG. 2 makes it possible to create holes of different diameters with a single tool.

For such use, the clamping of the hole saw advantageously always takes place at the opposite cylinder cross section from the cylinder cross section currently needed for hole production.

Thus, if the small cylinder cross section is needed, the clamping takes place at the large cylinder cross section, and vice versa.

The particular clamping surface 7 on the base body should therefore analogously have a straight-cylindrical shape, so that the clamping jaws of the drill chuck 8 can seat thereagainst, as illustrated particularly in the detailed representation of FIG. 3.

It is also advantageous for the base body 2, including its two ends 5, 6 and the hard particles 3 disposed there, to be given a colored coating, e.g., by being varnished or powder-coated or the like.

In this way, the current wear status of the tool can be monitored at all times.

### LIST OF REFERENCE NUMERALS

1 Hole saw
2 Base body
3 Hard particles
4 End face
5 First end
6 Second end
7 Clamping surface
8 Drill chuck

1. A hole saw (1) comprising a base body (2) having a cylindrical contour and of hard particles (4) annularly arranged on said base body (2) endwise thereof, wherein said hard particles (4) are disposed on both ends (5, 6) of said base body (2).

2. The hole saw (1) in accordance with claim 1, wherein the cylindrical contour of said base body (2) is provided with an outer clamping surface (7) for a drill chuck (8).

3. The hole saw (1) in accordance with claim 1, wherein said hard particles (3) are synthetic diamonds.

4. The hole saw (1) in accordance with claim 1, wherein said hard particles consist of carbide.

5. The hole saw (1) in accordance with claim 1, wherein said base body (2) has a larger cylinder cross section at a first end and a smaller cylinder cross section at a second end.

6. The hole saw (1) in accordance with claim 1, wherein said base body (2), including both ends (5, 6) and the hard particles (3) disposed thereon, is provided with a colored coating.

7. The hole saw (1) in accordance with claim 1, wherein said base body (2), viewed from said ends (5, 6), has the cylindrical contour, and a tubular cross section.
